(19) United States
(12) Patent Application Publication
(10) Pub. No.: US 2026/0187961 A1
(43) Pub. Date: Jul. 2, 2026

(54) IMAGE PROCESSING METHOD AND ELECTRONIC DEVICE

(71) Applicant: Samsung Electronics Co., Ltd., Suwon-si (KR)

(72) Inventors: Minchul Lee, Suwon-si (KR); Eitan Lavi, Tel-Aviv (IL); Seokyong Park, Suwon-si (KR); Jonghan Ahn, Suwon-si (KR); Jonghyuk Woo, Suwon-si (KR); Seunghyung Lee, Suwon-si (KR)

(21) Appl. No.: 19/387,085

(22) Filed: Nov. 12, 2025

(30) Foreign Application Priority Data
Dec. 30, 2024 (KR) 10-2024-0201170

(51) Int. Cl. G06V 10/25; G06T 3/40; G06T 7/73; G06V 10/80; G06V 20/59; G06V 40/16

(52) U.S. Cl. CPC G06V 10/25; G06T 3/40; G06T 7/73; G06V 10/803; G06V 20/59; G06V 40/166; G06T 2207/10024; G06T 2207/10048; G06T 2207/30201; G06T 2207/30268

(57) ABSTRACT

An image processing method is described of outputting a region of interest, in high resolution, from an image captured by a camera. The method includes outputting, by an image sensor, at least one of first intermediate data or third intermediate data, generating first image data having a first resolution based on at least one of the first intermediate data or the third intermediate data, extracting location information of the region of interest based on the first image data, and generating second image data having a second resolution based on second intermediate data output by the image sensor and the location information of the region of interest. The second resolution may be higher than the first resolution.

### CROSS-REFERENCE TO RELATED APPLICATION

This application is based on and claims priority under 35 U.S.C. § 119 to Korean Patent Application No. 10-2024-0201170, filed on Dec. 30, 2024, in the Korean Intellectual Property Office, the disclosure of which is incorporated by reference herein in its entirety.

### BACKGROUND

Electronic devices may be mounted with a camera (or a camera module) and may take pictures or videos. For example, electronic devices mounted with a camera may be mounted inside a vehicle and scan a subject or monitor inside the vehicle.

Electronic devices disposed inside the vehicle may capture the entire inside of the vehicle. In this regard, captured image data may include information about internal passengers including a driver.

### SUMMARY

An image processing method is described capable of obtaining a region, in high resolution, corresponding to a region of interest from captured image data.

This disclosure relates to an image processing method and an electronic device. More particularly, the disclosure relates to an image processing method capable of outputting a region of interest, in high resolution, from entire image data, and an electronic device capable of performing the method. When only part of the information included in the captured image data is to be selected and monitored, the captured image data needs to be scanned and processed entirely, which causes excessive data burden and increases system power.

An image processing method is provided.

The image processing method of outputting a region of interest, in high resolution, from an image captured by a camera includes outputting, by an image sensor, at least one of first intermediate data or third intermediate data, generating first image data having a first resolution based on at least one of the first intermediate data or the third intermediate data, extracting location information of the region of interest based on the first image data, and generating second image data having a second resolution based on second intermediate data output by the image sensor and the location information of the region of interest, wherein the second resolution is higher than the first resolution.

According to other implementations, there is provided an image processing method.

The image processing method of outputting a region of interest, in high resolution, from an image captured by a camera includes generating first intermediate data and second intermediate data from a pixel array of an image sensor, generating first image data by binning the first intermediate data or the second intermediate data, extracting location information of the region of interest based on the first image data, generating second image data by extracting a region corresponding to the region of interest from the second intermediate data, and merging the first image data with the second image data.

According to other implementations, there is provided an electronic device.

The electronic device includes a camera module configured to capture an object and output image data, and a processor configured to process the image data, wherein the camera module includes an image sensor, and an image processing circuit configured to process pixel data output from the image sensor and output first image data and second image data, the first image data is data obtained by outputting an entire region, in a first resolution, of the image data obtained by capturing the object, the second image data is data obtained by outputting only a region, in a second resolution, corresponding to a region of interest from the image data obtained by capturing the object, and the first resolution is lower than the second resolution.

### BRIEF DESCRIPTION OF THE DRAWINGS

Implementations will be more clearly understood from the following detailed description taken in conjunction with the accompanying drawings in which:

FIGS. 1A and 1B are diagrams illustrating an example of a location where a camera is installed and an image captured accordingly according to some implementations;

FIG. 2 is a block diagram illustrating an electronic device according to some implementations;

FIG. 3 is a block diagram illustrating configurations of a camera module and a processor according to some implementations;

FIG. 4 is a block diagram for briefly explaining a configuration of an image processing circuit;

FIG. 5 is a flowchart for explaining data output between components according to some implementations;

FIGS. 6A to 6D are diagrams for explaining pixel data corresponding to first image data, first intermediate data, second intermediate data, and third intermediate data according to some implementations;

FIG. 7 is a diagram illustrating an image processing method according to some implementations;

FIG. 8 is a block diagram illustrating an image processing circuit according to some implementations; and

FIG. 9 is a flowchart illustrating an image processing method according to some implementations.

### DETAILED DESCRIPTION

Hereinafter, various implementations are described with reference to the accompanying drawings.

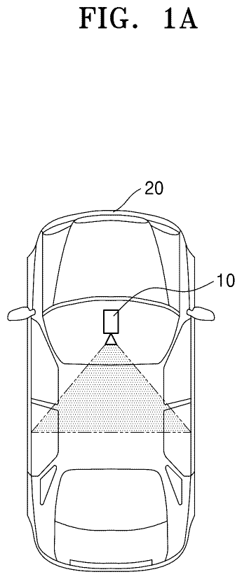

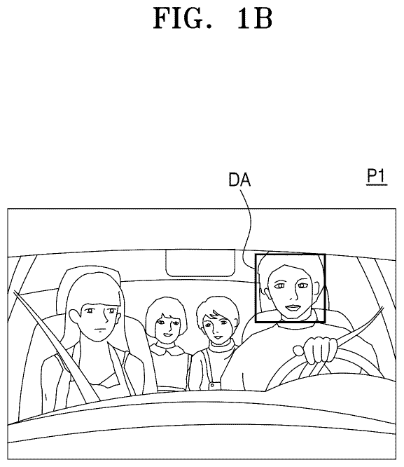

FIGS. 1A and 1B are diagrams illustrating an example of a location where a camera 10 is installed and an image P1 captured accordingly according to some implementations.

Referring to FIG. 1A, the camera 10 according to an example may be a camera installed inside a vehicle 20. The camera 10 according to an example may include an image sensor, and may be disposed near the windshield of the vehicle 20 to monitor and capture the inside of the vehicle 20. The camera 10 according to an example may be a camera included in a driver and occupant monitoring system (DOMS) that monitors a driver and a passenger inside the vehicle 20.

FIG. 1B illustrates an example of the image P1 captured by the camera 10 of FIG. 1A. The image P1 shows a driver holding the steering wheel and passengers in the passenger seat and the back seats. In the DOMS according to an example, when passengers are inside the vehicle, the driver's face may be of the highest importance in terms of relative importance. Therefore, only a region DA corresponding to the driver's face in the entire region of the image P1 needs high resolution, and low resolution may be sufficient with respect to the remaining region of the image P1 except for the region DA corresponding to the driver's face.

Methods and devices capable of outputting only a part, in high resolution, corresponding to a desired region in the entire image P1 captured by the camera 10 will be described.

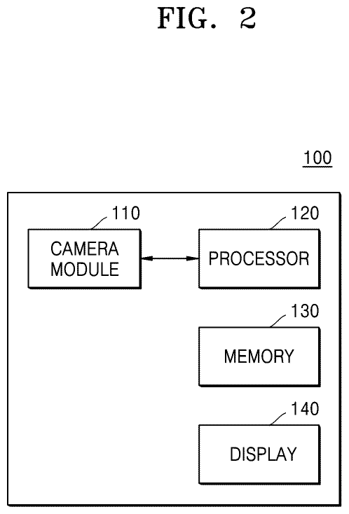

FIG. 2 is a block diagram illustrating an electronic device 100 according to some implementations.

The electronic device 100 of FIG. 2 may include a camera module 110, a processor 120, a memory 130, and a display 140. According to an example, the electronic device 100 may be an electronic device including the camera 10 shown in FIG. 1A or an electronic device mounted inside the vehicle 20. According to some implementations, the camera module 110 included in the electronic device 100 may correspond to the camera 10 of FIG. 1A.

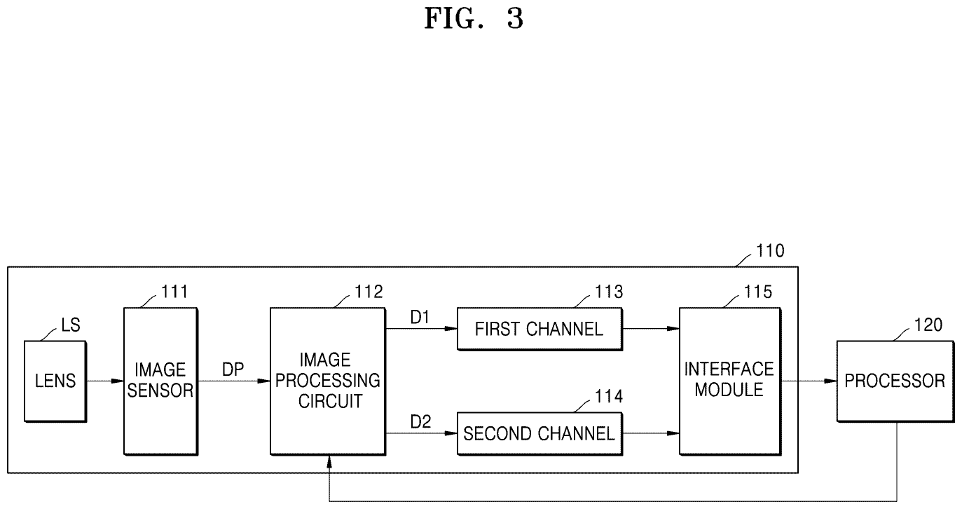

According to an example, the camera module 110 may capture a still image and a video. According to some implementations, the camera module 110 may include one or more lenses, image sensors, and an image processing circuit. The camera module 110 may be installed at an angle capable of capturing a driver and passengers inside the vehicle 20 (e.g., FIG. 1B). The camera module 110 may include an image sensor and an image processing circuit, and the image processing circuit may obtain raw image data in which an infrared band and a visible ray band correspond to light with respect to an external object. The image processing circuit may generate and output image data corresponding to a region of interest having high resolution, based on the raw image data. A detailed configuration of the camera module 110 will be described in more detail below with reference to FIG. 3.

According to an example, the processor 120 may execute software to control at least one other component (e.g., a hardware or software component) of the electronic device 100 connected to the processor 120 and may perform various data processing or operations. According to an example, the processor 120 may be a central processing unit or an application processor. According to an example, the processor 120 may be implemented as a system on chip (SoC). According to some implementations, the processor 120 may control the overall operation of the electronic device 100.

According to an example, the memory 130 may store commands or data related to at least one component (the camera module 110 or the processor 120) of the electronic device 100. For example, the memory 130 may store an image data file as the final result processed by the camera module 110. As another example, the memory 130 may store a plurality of applications providing a function by using at least one of an RGB image or an IR image. The memory 130 may include a volatile memory or a nonvolatile memory.

According to an example, the display 140 may visually provide information to the outside (e.g., a user) of the electronic device 100. According to an example, the display 140 may include a liquid crystal display (LCD), an LED display, an organic LED (OLED) display, a microelectromechanical systems (MEMS) display, or an electronic paper display. The display 140 may display, for example, image data generated in real time by the camera module 110. According to an example, the electronic device 100 may output image data as a result of monitoring by the camera module 110 on the display 140. According to some implementations, the display 140 may output a face region of the driver, in high resolution, monitored by the camera module 110.

FIG. 3 is a block diagram illustrating configurations of the camera module 110 and the processor 120 according to some implementations.

Referring to FIG. 3, the camera module 110 may include an image sensor 111, an image processing circuit 112, a first channel 113, a second channel 114, an interface module 115, and a lens LS.

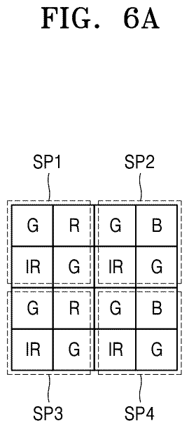

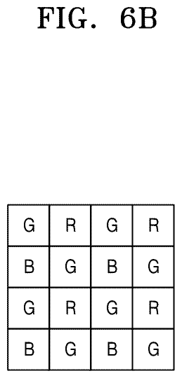

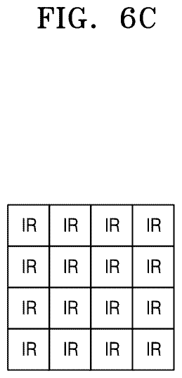

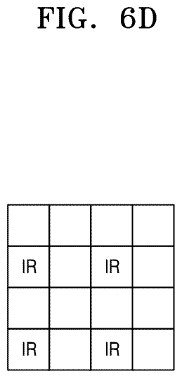

The image sensor 111 may generate an electrical signal that is a base of image data, in response to light received through the lens LS. The image sensor 111 may convert an optical signal of an object to be captured into image data. The image sensor 111 may include a pixel array and a readout circuit. The pixel array according to an example may be implemented into a photoelectric conversion device such as a charge-coupled device (CCD) or a complementary metal oxide semiconductor (CMOS) device, and other types of photoelectric conversion devices. The pixel array may include a plurality of pixels converting a received optical signal (light) into an electrical signal, and the plurality of pixels may be arranged in rows and columns. Each of the plurality of pixels includes a light detection device. For example, the light detection device may include a photodiode, a photo transistor, a port gate, or a pinned photodiode. According to some implementations, each of the pixels may include an R subpixel, a G subpixel, a B subpixel, and an IR subpixel. According to some implementations, the R subpixel may receive red light, the G subpixel may receive green light, the B subpixel may receive blue light, and the IR subpixel may receive infrared light. The pixel array according to an example may include one IR subpixel, two G subpixels, and one R subpixel with respect to a 2×2 matrix. In this regard, a specific example will be described below with reference to FIG. 6A.

The readout circuit according to an example may convert electrical signals received from the pixel array into image data. The readout circuit may amplify electrical signals received from the pixel array and analog-to-digital convert the amplified electrical signals. The image data generated and output by the readout circuit may include pixel data corresponding to each of the pixels of the pixel array. The image sensor 111 may output pixel data DP corresponding to each of the pixels of the pixel array. The pixel data DP may be raw image data corresponding to light in an infrared band and a visible band with respect to an external object.

The image processing circuit 112 may perform image processing on the pixel data DP by a plurality of pixels of the image sensor 111. The image processing circuit 112 may output first image data D1 and second image data D2 by performing image processing on the pixel data DP in three ways and performing binning processing and crop processing based on the image-processed data.

According to an example, the first image data D1 may be data obtained by selecting any one of data obtained by processing the pixel data DP and binning the selected data. According to an example, the first image data D1 may be image data having resolution lower than the resolution of the pixel data DP.

According to an example, the second image data D2 may be data that is output by cropping a region of interest based on the data obtained by processing the pixel data DP. According to an example, the second image data D2 may be image data having resolution equal to or higher than the resolution of the pixel data DP.

The image processing circuit 112 may transmit the first image data D1 and the second image data D2 through the first channel 113 and the second channel 114, respectively. According to some implementations, the first channel 113 and the second channel 114 may be different channels.

According to some implementations, the image processing circuit 112 may transmit the first image data D1 corresponding to the entire region having a first resolution to the processor 120 through the first channel 113. According to some implementations, the image processing circuit 112 may transmit the second image data D2 corresponding to a region of interest having a second resolution to the processor 120 through the second channel 114. According to some implementations, the image processing circuit 112 may transmit the first image data D1 and the second image data D2 to the processor 120 in parallel through the first channel 113 and the second channel 114.

According to some implementations, the first channel 113 and the second channel 114 may include channels related to a mobile industry processor interface (MIPI). According to some implementations, each of the first channel 113 and the second channel 114 may be implemented as a physically separated channel. According to an example, each of the first channel 113 and the second channel 114 may be implemented as a logically separated channel (e.g., a virtual channel). According to some implementations, the first channel 113 may include a first virtual channel related to the MIPI, and the second channel 114 may include a second virtual channel related to the MIPI.

The first channel 113 and the second channel 114 may be connected to the interface module 115, and the interface module 115 may transmit at least one of the first image data D1 or the second image data D2 to the processor 120.

According to some implementations, the processor 120 may be connected to the image processing circuit 112 of the camera module 110. The processor 120 may further include a face detection (FD) detection circuit capable of extracting location information of a region of interest based on the first image data D1. The processor 120 may detect a region of interest, for example, a face region of the driver, based on the first image data D1 having low resolution, and transmit a signal including location information of the corresponding region to the image processing circuit 112. The image processing circuit 112 may generate the second image data D2 based on the corresponding information.

The camera module 110 according to some implementations may output the first image data D1 having low resolution and the second image data D2 outputting the region, in high resolution, corresponding to the region of interest, based on the pixel data DP by the image sensor 111 and the signal received by the processor 120, through the first channel 113 and the second channel 114. Accordingly, a bandwidth of data may be reduced, and only desired data may be output in high resolution, and thus power consumed by the processor 120 may be reduced. In addition, the first image data D1 and the second image data D2 in a smaller size than the pixel data DP are output, and thus a low-cost interface and chip may be used, which may be efficient in terms of cost.

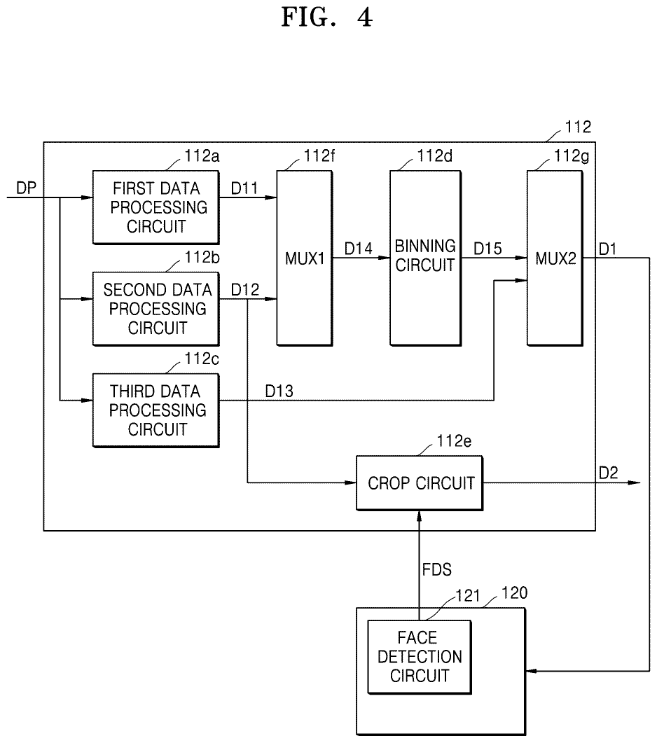

FIG. 4 is a block diagram for briefly explaining a configuration of the image processing circuit 112.

Referring to FIG. 4, the image processing circuit 112 may include a first data processing circuit 112a, a second data processing circuit 112b, a third data processing circuit 112c, a binning circuit 112d, a crop circuit 112e, a first multiplexer 112f, and a second multiplexer 112g.

The first data processing circuit 112a, the second data processing circuit 112b, and the third data processing circuit 112c may receive the pixel data DP and perform data processing. According to an example, the first data processing circuit 112a may receive the pixel data DP, perform first data processing on the pixel data DP, and output the first data processed pixel data as first intermediate data D11. The second data processing circuit 112b may receive the pixel data DP, perform second data processing on the pixel data DP, and output the second data processed pixel data as second intermediate data D12. The third data processing circuit 112c may receive the pixel data DP, perform third data processing on the pixel data DP, and output the third data processed pixel data as third intermediate data D13. According to an example, the first intermediate data D11, the second intermediate data D12, and the third intermediate data D13 may be data generated through different data processing, or may be different data.

According to an example, the pixel data DP may be image data corresponding to a plurality of pixels included in a pixel array. According to some implementations, each of the plurality of pixels may include an R subpixel, a G subpixel, a B subpixel, and an IR subpixel. The pixel data DP may be raw image data including all data of different subpixels included in the plurality of pixels. According to another example, the pixel data DP may be image data as a result of performing defective pixel correction (DPC), frame white balance, and/or noise reduction.

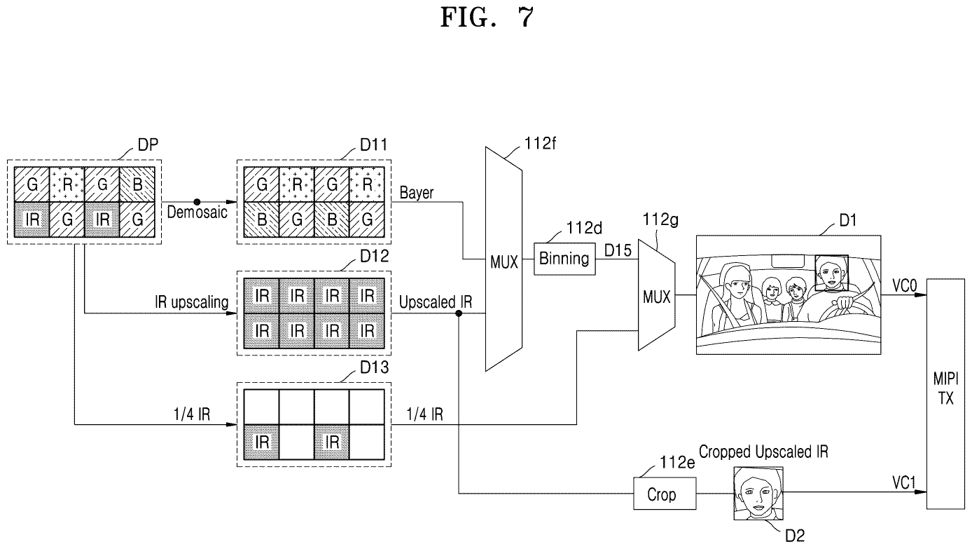

According to an example, the first intermediate data D11 may be image data generated by demosaicing some subpixel data of the pixel data DP. According to an example, the second intermediate data D12 may be image data generated by upscaling some subpixel data of the pixel data DP. According to an example, the third intermediate data D13 may be image data generated by extracting only some subpixel data from the pixel data DP. According to an example, the first intermediate data D11 and the second intermediate data D12 may be image data generated by rearranging pixels while having the same size as the pixel data DP, and the third intermediate data D13 may be image data having low resolution and a small size compared to the pixel data DP. Hereinafter, an example of data corresponding to the pixel data DP, the first intermediate data D11, the second intermediate data D12, and the third intermediate data D13 will be described in more detail with reference to FIGS. 6A to 7.

According to an example, the first multiplexer 112f may receive the first intermediate data D11 and the second intermediate data D12. The first multiplexer 112f may select one of the first intermediate data D11 and the second intermediate data D12 and output the selected one as fourth intermediate data D14. The fourth intermediate data D14 may be data to be binning processed.

The binning circuit 112d may receive the fourth intermediate data D14 to perform binning processing on the fourth intermediate data D14, and accordingly, may output binning data D15. The binning data D15 may be data obtained by binning the first intermediate data D11 or data obtained by binning the second intermediate data D12. The binning data D15 may be image data having a resolution lower than the resolution of the fourth intermediate data D14 by binning processing.

The second multiplexer 112g may receive the binning data D15 and the third intermediate data D13 as an inputs. The second multiplexer 112g may output any one of the binning data D15 and the third intermediate data D13 as the first image data D1. The first image data D1 may be image data having low resolution compared to the pixel data DP. The first image data D1 may be output through a first channel. According to an example, the resolution of the first image data D1 may be lower than the resolutions of the first intermediate data D11 and the second intermediate data D12.

The processor 120 of FIG. 4 may receive the first image data D1 through a first channel. The processor 120 may further include an face detection circuit 121. The face detection circuit 121 may be a circuit that detects location information of a region of interest included in the first image data D1. According to an example, the face detection circuit 121 may detect the location of a face region of a driver included in the first image data D1. According to an example, the face detection circuit 121 may identify the location of the face region of the driver from the first image data D1 and derive coordinate information corresponding to the face region and the size of the corresponding region. The face detection circuit 121 may transmit an FD detection signal FDS including the coordinate information and the size of the corresponding region to the crop circuit 112e.

The crop circuit 112e may receive the second intermediate data D12, which is the output of the second data processing circuit 112b, and the FD detection signal FDS. The crop circuit 112e may obtain image data having high resolution of the region corresponding to the region of interest by applying coordinates included in the FD detection signal FDS to the second intermediate data D12 having high resolution. The crop circuit 112e may output the second image data D2, which is image data corresponding to the region of interest having high resolution.

According to some implementations, the image processing circuit 112 may output image data having low resolution corresponding to the entire region and image data having high resolution corresponding to the region of interest sequentially or simultaneously, thereby obtaining the image data having high resolution only in the desired region, and may not need to output image data having high resolution in the unnecessary region, thereby increasing the data processing speed and reducing processing power.

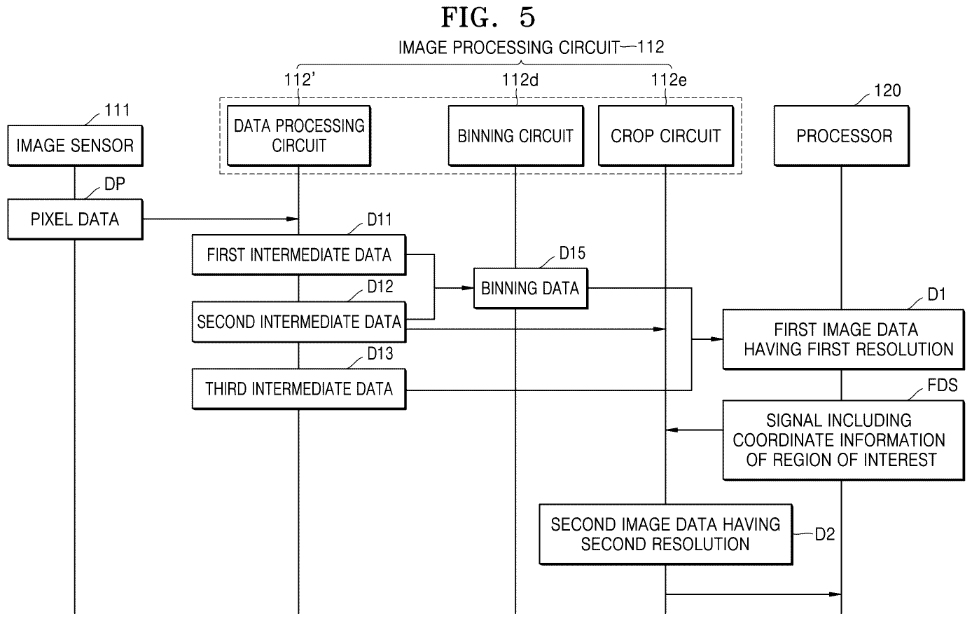

FIG. 5 is a flowchart for explaining data output between components according to some implementations.

Referring to FIG. 5, the image sensor 111 may transfer the pixel data DP to the image processing circuit 112. According to an example, the pixel data DP may be input to a data processing circuit 112′ including the first data processing circuit 112a, the second data processing circuit 112b, and the third data processing circuit 112c.

The data processing circuit 112′ may perform data processing based on the pixel data DP to generate the first intermediate data D11, the second intermediate data D12, and the third intermediate data D13.

The first intermediate data D11 and the second intermediate data D12 may be data provided to the binning circuit 112d for binning processing. The binning circuit 112d may select one of the first intermediate data D11 and the second intermediate data D12, perform binning processing on the selected one, and generate binning data D15.

The binning data D15 and the third intermediate data D13 may be provided to a second multiplexer, and the second multiplexer may select one of the binning data D15 and the third intermediate data D13 and output the first image data D1 to the processor 120. The first image data D1 received by the processor 120 may be data having a first resolution. The first image data D1 may be data having low resolution compared to the pixel data DP by binning or third data processing. The first image data D1 may be data including the same image region as an image region included in the pixel data DP.

The processor 120 may detect location information of a region of interest based on the first image data D1, and accordingly, detect coordinate information of the region of interest and the size of the corresponding region. The processor 120 may generate the FD detection signal FDS including the coordinate information of the region of interest and the size of the corresponding region, and transmit the same to the crop circuit 112e.

The crop circuit 112e may receive the FD detection signal FDS including the coordinate information of the region of interest and the size of the corresponding region, and the second intermediate data D12. The crop circuit 112e may obtain image data having high resolution, based on the second intermediate data D12, and based on the image data, crop only a region corresponding to the coordinate information of the region of interest, and generate the second image data D2. The second image data D2 may be data having a second resolution. The second resolution may be higher than the first resolution. For example, the second resolution may be the maximum resolution (or full resolution) supported by a camera module.

The second image data D2 may be transmitted to the processor 120, and the processor 120 may effectively monitor an in-vehicle system by utilizing the second image data D2. According to another example, the processor 120 may merge the first image data D1 with the second image data D2 and effectively monitor the in-vehicle system by utilizing the merged data.

In the implementations of FIGS. 4 to 5, an example of generating the second image data D2 based on the second intermediate data D12 has been shown, but according to another example, the second image data D2 may be generated based on the first intermediate data D11. According to an example, the image data that is a base for generating the second image data D2 may be any one of pieces of image data having high resolution.

FIGS. 6A to 6D are diagrams for explaining pixel data corresponding to first image data, first intermediate data, second intermediate data, and third intermediate data according to some implementations.

FIG. 6A illustrates some of pixels included in a pixel array included in the image sensor 111 of FIG. 3. According to an example, the pixel array may include a plurality of pixels disposed according to a plurality of rows and columns, and may include, for example, each of shared pixels defined as a unit including pixels disposed in two rows and two columns may include four subpixels. In other words, the shared pixel may include four photodiodes respectively corresponding to the four subpixels.

Referring to FIG. 6A, a first shared pixel SP1 may include two G subpixels, one R subpixel, and one IR subpixel. A second shared pixel SP2 may include two G subpixels, one B subpixel, and one IR subpixel. A third shared pixel SP3 may include two G subpixels, one R subpixel, and one IR subpixel. A fourth shared pixel SP4 may include two G subpixels, one B subpixel, and one IR subpixel. The shared pixels included in the pixel array according to an example may include one IR subpixel and three color subpixels. According to some implementations, the R subpixel may receive red light, the G subpixel may receive green light, the B subpixel may receive blue light, and the IR subpixel may receive infrared light. According to an example, the pixel data DP output from the image sensor 111 may be image data output according to a pixel arrangement of FIG. 6A.

FIG. 6B illustrates pixels in a pixel arrangement corresponding to the first intermediate data D11. Pixel data shown in FIG. 6B may be pixel data generated through demosaicing using the R subpixel data, the G subpixel data, and the B subpixel data, except for the IR subpixel data. According to an example, the first intermediate data D11 may include RGB information.

FIG. 6C illustrates pixels in a pixel arrangement corresponding to the second intermediate data D12. Pixel data shown in FIG. 6C may be pixel data generated through upscaling using the IR subpixel data, except for the R subpixel data, the G subpixel data, and the B subpixel data. According to an example, the second intermediate data D12 may include IR information.

FIG. 6D illustrates pixels in a pixel arrangement corresponding to the third intermediate data D13. Pixel data shown in FIG. 6D may be pixel data generated using only the IR subpixel data except for the R subpixel data, the G subpixel data, and the B subpixel data. According to an example, the third intermediate data D13 may include IR information.

FIGS. 6A to 6D illustrate an example of generating a pixel array corresponding to the first intermediate data D11, a pixel array corresponding to the second intermediate data D12, and a pixel array corresponding to the third intermediate data D13 based on pixel array data corresponding to the pixel data DP of FIG. 6A.

According to an example, the pixel data DP, the first intermediate data D11 and the second intermediate data D12 may have the same data bit size and resolution. The pixel data DP and the third intermediate data D13 may have different data sizes and resolutions. The data size of the pixel data DP may be four times the data size of the third intermediate data D13. Each of the pixel data DP, the first intermediate data D11, and the second intermediate data D12 may have high resolution, and the third intermediate data D13 may have low resolution.

Hereinafter, an example of performing image processing using the pixel data of FIGS. 6A to 6D will be described with reference to FIG. 7.

FIG. 7 is a diagram illustrating an image processing method according to some implementations.

FIG. 7 illustrates the pixel data DP including G subpixel data, R subpixel data, B subpixel data, and IR subpixel data. The first intermediate data D11 is generated by demosaicing the G subpixel data, the R subpixel data, and the B subpixel data included in the pixel data DP except for the IR subpixel data. In an example, the first intermediate data D11 may be in a Bayer pattern.

The second data D12 is generated by applying an upscaling method that converts the R, G, and B subpixel data into IR subpixel data and changes the R, G, and B subpixel data into IR subpixel data by interpolating IR subpixel data included in the pixel data DP.

The third intermediate data D13 is generated by outputting only the IR subpixel data included in the pixel data DP except for the G subpixel data, the R subpixel data, and the B subpixel data included in the pixel data DP.

According to an example, the first intermediate data D11 and the second intermediate data D12 may have the same bit size. In order to reduce the bit size of the first intermediate data D11 and the second intermediate data D12, the first intermediate data D11 and the second intermediate data D12 may be input to the binning circuit 112d through the first multiplexer 112f. The binning circuit 112d may input, to the second multiplexer 112g, the binning data D15 having the reduced data size by binning the first intermediate data D11 or the second intermediate data D12. According to an example, the binning data D15 may be a quarter of the bit sizes of the first intermediate data D11 and the second intermediate data D12.

The third intermediate data D13 and the binning data D15 may be input to the second multiplexer 112g so that any one of image data including only IR subpixel data and image data on which binning is performed may be output as the first image data D1. According to an example, the size of the third intermediate data D13 may also be a quarter of the bit sizes of the first intermediate data D11 and the second intermediate data D12. The data input to the second multiplexer 112g may be image data having the reduced data size and low resolution compared to the pixel data DP.

Based on the first image data D1 output by the second multiplexer 112g, the location of a region of interest may be detected, and coordinate information of the region of interest and the size of the region may be transferred to the crop circuit 112e. The region of interest may be detected through the first image data D1 having low resolution, and thus data consumption and power consumption may be significantly reduced compared to detecting the region of interest through image data having high resolution.

The crop circuit 112e may output the second image data D2, which is a result of outputting a desired region of interest in high resolution by applying coordinates of the region of interest, based on the first intermediate data D11 or the second intermediate data D12, which is an image having high resolution. According to an example, the second image data D2 also has the same resolution as the pixel data DP, but includes only a crop region, and thus the data size may be reduced compared to the pixel data DP.

According to some implementations, data finally output by an image processing circuit may be the second image data D2 with respect to the region of interest having high resolution and the first image data D1 corresponding to the entire image having low resolution, and accordingly, only the desired region may be extracted in high resolution, thereby reducing system power compared to some implementations in which a region of interest is extracted from data having high resolution according to comparative implementations. According to some implementations, both the first image data D1 and the second image data D2 may have the reduced data size compared to the pixel data DP.

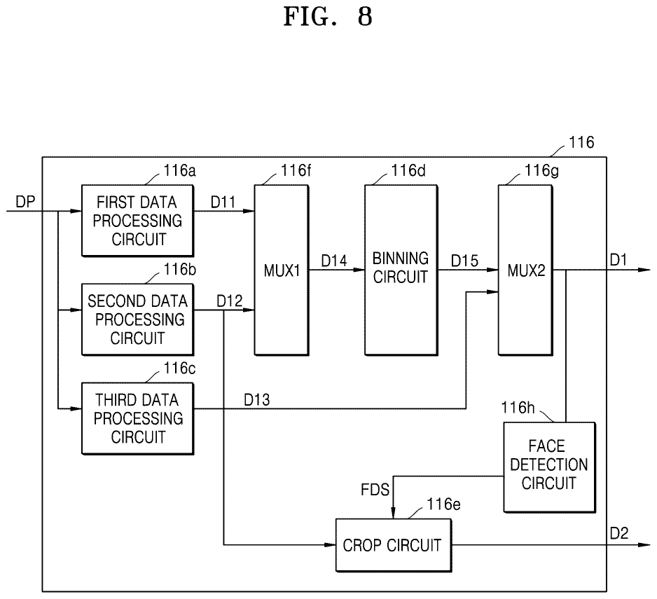

FIG. 8 is a block diagram illustrating an image processing circuit 116 according to some implementations. In FIG. 8, redundant descriptions with those of the implementations described with reference to FIG. 4 will be omitted.

The image processing circuit 116 of FIG. 8 may include a first data processing circuit 116a, a second data processing circuit 116b, a third data processing circuit 116c, a binning circuit 116d, a crop circuit 116e, a first multiplexer 116f, a second multiplexer 116g, and a face detection circuit 116h.

The configurations of the first data processing circuit 116a, the second data processing circuit 116b, the third data processing circuit 116c, the binning circuit 116d, the first multiplexer 116f, and the second multiplexer 116g of the image processing circuit 116 of FIG. 8 respectively correspond to the configurations of the first data processing circuit 112a, the second data processing circuit 112b, the third data processing circuit 112c, the binning circuit 112d, the first multiplexer 112f, and the second multiplexer 112g of the image processing circuit 112 of FIG. 4, and thus redundant descriptions thereof are omitted.

The image processing circuit 116 of FIG. 8 may include the face detection circuit 116h. In comparison with the image processing circuit 112 of FIG. 4, the image processing circuit 116 of FIG. 8 may include the face detection circuit 116h therein.

The face detection circuit 116h may receive the first image data D1 as an input, and may detect a region of interest based on the received first image data D1. The face detection circuit 116h may extract coordinates of the region of interest and transmit the FD detection signal FDS including the coordinates to the crop circuit 116e.

The crop circuit 116e may obtain image data having high resolution corresponding to the region of interest, based on the FD detection signal FDS and the second intermediate data D12.

According to some implementations of FIG. 8, the image processing circuit 116 may also be configured to include the face detection circuit 116h by itself.

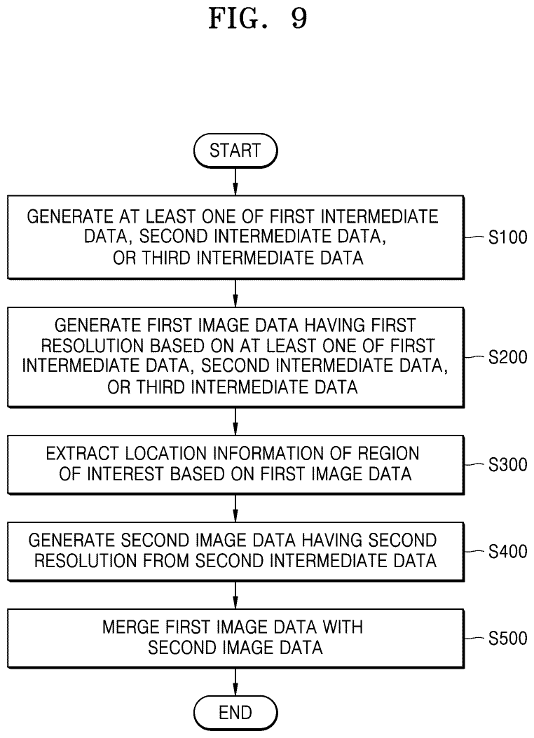

FIG. 9 is a flowchart illustrating an image processing method according to some implementations.

Referring to operation S100, an image processing circuit may generate at least one of first intermediate data, second intermediate data, or third intermediate data. The first intermediate data, the second intermediate data, and the third intermediate data may be data generated based on pixel data by an image sensor.

Referring to operation S200, the image processing circuit may generate first image data having a first resolution based on at least one of the first intermediate data, the second intermediate data, or the third intermediate data. According to an example, the first image data having the first resolution may be generated based on binning data obtained by binning the first intermediate data or the second intermediate data. According to another example, the first image data having the first resolution may be generated based on the third intermediate data in which only a region corresponding to subpixel data is extracted from pixel data. The first image data may be image data having a lower resolution than that of the pixel data, but include the same region as a capturing region of the pixel data.

Referring to operation S300, a processor or the image processing circuit may detect the region of interest based on the first image data, and detect corresponding coordinate information and the size of the region. According to an example, the processor or the image processing circuit may detect a location of the region of interest based on the first image data, and detect coordinate information of the corresponding location and the size of the corresponding region. According to an example, the region of interest may include a face region of a driver. The processor or the image processing circuit may detect coordinate information corresponding to the face region and the size of the face region detected, generate a signal including the corresponding information, and transmit the signal to a crop circuit.

Referring to operation S400, the crop circuit may generate second image data having a second resolution based on the coordinate information and the second intermediate data. According to an example, the second image data may be image data including only a region corresponding to the region of interest and having a high resolution.

Referring to operation S500, the image processing circuit or the processor may output an image by merging the first image data with the second image data.

A method of outputting a corresponding region in high resolution by using a face region of a driver as a region of interest is disclosed, but implementations may not be limited thereto, and the region of interest may be set differently according to a user's setting. According to an example, the processing method may also be applied to a method of outputting, in high resolution, a face region of a passenger sitting in a passenger seat by using the face region as a region of interest. According to another example, it should be noted that, in addition to a monitoring system within a vehicle, the processing method may be applied even when a region of interest is to be output in high resolution by using any one region as the region of interest in any specific monitoring or surveillance situation.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the image processing method has been particularly shown and described with reference to implementations thereof, it will be understood that various changes in form and details may be made therein without departing from the spirit and scope of the following claims.

What is claimed is:

1. An image processing method of outputting a region of interest comprising:
outputting, by a plurality of pixels, at least one of first intermediate data or third intermediate data;
generating first image data having a first resolution based on at least one of the first intermediate data or the third intermediate data;
extracting location information of the region of interest based on the first image data; and
generating second image data having a second resolution based on second intermediate data output by the plurality of pixels and the location information of the region of interest,
wherein the second resolution is higher than the first resolution, and
wherein the plurality of pixels comprise a plurality of red subpixels, blue subpixels, green subpixels, and infrared subpixels.

2. The image processing method of claim 1, wherein
the first intermediate data comprises RGB information, and
each of the second intermediate data and the third intermediate data comprises infrared information.

3. The image processing method of claim 2, wherein
the second intermediate data is data generated by upscaling at least one infrared subpixel data from the plurality of pixels, and
the third intermediate data is data generated by extracting at least one infrared subpixel data from the plurality of pixels.

4. The image processing method of claim 2, wherein
the first image data is output through a first channel, and
the second image data is output through a second channel.

5. The image processing method of claim 4, wherein the region of interest comprises a driver's face.

6. The image processing method of claim 5, wherein the first image data is generated by binning the first intermediate data.

7. The image processing method of claim 5, wherein the plurality of pixels comprises one infrared subpixel, two green subpixels, and one red subpixel arranged in a 2×2 matrix.

8. The image processing method of claim 1, wherein the first image data and the second image data are configured to be outputted through a mobile industry processor interface.

9. The image processing method of claim 1, wherein the second intermediate data is data generated by upscaling one infrared subpixel data from the plurality of pixels, and
wherein the third intermediate data is data generated based on the one infrared subpixel data.

10. An image processing method of outputting a region of interest comprising:
generating first intermediate data and second intermediate data from a plurality of pixels;
generating first image data by binning the first intermediate data or the second intermediate data;
extracting location information of the region of interest based on the first image data;
generating second image data by extracting a region corresponding to the region of interest from the second intermediate data; and
merging the first image data with the second image data,
wherein the plurality of pixels comprise a plurality of red subpixels, blue subpixels, green subpixels, and infrared subpixels.

11. The image processing method of claim 10, wherein
the first image data comprises data corresponding to a red subpixel data, a green subpixel data, and a blue subpixel data, and
the second image data comprises data corresponding to an infrared subpixel data.

12. The image processing method of claim 11, wherein the first intermediate data comprises data obtained by demosaicing data corresponding to the red subpixel data, the green subpixel data, and the blue subpixel data from the plurality of pixels.

13. The image processing method of claim 11, wherein the second intermediate data comprises data obtained by upscaling data corresponding to the infrared subpixel data from the plurality of pixels.

14. The image processing method of claim 10, wherein the region of interest comprises a driver's face.

15. An electronic device comprising:
a camera module configured to capture an object and output image data; and
a processor configured to process the image data,
wherein the camera module comprises
an image processing circuit configured to process pixel data output from a plurality of pixels and output first image data and second image data,
wherein the first image data is data obtained by outputting an entire region, in a first resolution, of the image data obtained by capturing the object,
wherein the second image data is data obtained by outputting only a region, in a second resolution, corresponding to a region of interest from the image data obtained by capturing the object, and
wherein the first resolution is lower than the second resolution.

16. The electronic device of claim 15, wherein
the first image data is output through a first channel,
the second image data is output through a second channel, and
each of the first channel and the second channel is a virtual channel.

17. The electronic device of claim 15, wherein the processor comprises a face detection circuit configured to detect location information of the region of interest, generate a signal comprising coordinate information of the region of interest and size information of the region, and transmit the signal to the image processing circuit.

18. The electronic device of claim 15, wherein the image processing circuit comprises a face detection circuit configured to detect a location of the region of interest and generate a signal comprising coordinate information of the region of interest and size information of the region.

19. The electronic device of claim 17, wherein the image processing circuit is configured to generate the second image data based on the signal comprising the coordinate information of the region of interest and the size information of the region.

20. The electronic device of claim 19, wherein the image processing circuit is configured to generate the second image data by cropping a region corresponding to the coordinate information in accordance with the size information based on the signal comprising the coordinate information of the region of interest and the size information of the region.
